(19) United States
(12) Patent Application Publication
(10) Pub. No.: US 2005/0285021 A1
(43) Pub. Date: Dec. 29, 2005

(54) Optical device and method for manufacturing the same

(76) Inventors: Ho-Feng Chiu, Hsintien City (TW); Cheng-Chung Kuo, Taipei City (TW); Jen-Chun Weng, Taipei City (TW)

Correspondence Address: RABIN & BERDO, P.C.;Suite 500, 1101 14 Street, N.W., Washington, DC, 20005, US

(21) Appl. No.: 11/060,436

(22) Filed: Feb. 18, 2005

(30) Foreign Application Priority Data
Jun. 25, 2004 (TW) 93118538

(51) Int. Cl. H01J 3/14

(52) U.S. Cl. 250/216

(57) ABSTRACT

An optical device includes a conductive frame, a sensor member mounted on a lower surface of the conductive frame, an aperture member covering the sensor member and having an aperture corresponding to the sensor member, a lighting member arranged on an extension portion of the conductive frame; and a protection member packaging the lighting member and the aperture member onto the conductive frame. The protection member is transparent and made integrally in one piece with the conductive frame, and the protection member has a light-condensing portion protruded therefrom and relative to the aperture and the sensor member sequentially. The lighting member provides light onto an object, which is disposed beneath the protection member, and the light is reflected to the light-condensing portion and further incident into the sensor member via the aperture member.

### BACKGROUND OF THE INVENTION

1. Field of the Invention

The present invention relates to an optical device and method for manufacturing the same, and particularly relates to an optical device and method for manufacturing the same, which can be applied with all kinds of imaging systems that include a light source and a sensor.

2. Background of the Invention

An optical imaging system is composed of a sensor, a light source and an optical lens; for example, an optical mouse has a light source to provide light to a surface of an object (such as a surface of a table or a mouse pad), and the optical mouse has a lens for imaging the surface of the object. Because the surface is often rough and uneven, the sensor catches and compares sequential images to obtain the mobility information of a cursor on a computer screen, which means an image caught at a prior time and another image caught at a later time are compared to check the moving direction and the distance of the cursor.

FIG. 1 illustrates a side view of a first conventional optical imaging system disclosed in U.S. Pat. No. 4,751,505. An optical imaging system 100a includes a LED lighting source 106a arranged on a base 107a at a fixed incident angle. The LED lighting source 106a is processed with a bent lead for mounting on a PCB 118a. The optical imaging system 100a further includes a sensor 128a with an IC 124a; the base 107a and the IC 124a are mounted on the PCB 118a, too. A lens 120a is disposed beneath the IC 124a to project an image on the sensor 128a. A light-guiding member 122a is in an elongated hollow pillar shape, and the light-guiding member 122a is arranged between the lens 120a and the IC 124a to shield the stray light and to secure the lens 120a.

FIG. 2 illustrates a side view of a second conventional optical imaging system disclosed by a design made by HP tech., with part number HDNS-2000. An optical imaging system includes an LED lighting source 44b secured on a base 46b. A lens set 30b makes a proper light delivery passageway between the lighting source 44b and a sensor 160b. The lens set 30b is used to guide and reflect the light from the lighting source 44b in a predetermined incident angle. The sensor 160b is arranged onto a conductive frame 170b and in a vacancy inside a black covering 150b that is injected molded. A lower lid 180b encloses the black covering 150b and has an aperture 181b formed therein to shield the stray light in order to guarantee the image quality. For protecting the sensor 160b from dust during assembly, the sensor 160b is coated with a layer of a transparent silicon 190b. In addition, the lens set 30b includes a lens 32b for an image. A PCB 100b is used to secure the lighting source 44b, and also secure the sensor 160b via the conductive frame 170b.

However, each of the first and the second conventional optical systems combines pluralities of optical components into a whole. Each optical component is produced by various process and further assembled together; thus, a difference existing between two assembled components will effect the image quality that needs high assembly precision between the lighting source 106a, 44b. In addition, the second conventional optical system includes a light pipe assembled in the lens set to provide a reflection and a refraction of the light; however, the light pipe causes optical losses and reduces the lighting efficiency. Furthermore, when the lower lid 180b is assembled to the second conventional optical system, the transparent silicon layer 190b is indisputably contaminated with dust, which means the image quality is reduced or, more seriously, the product will fail to work.

Hence, an improvement over the prior art is required to overcome the disadvantages thereof.

### SUMMARY OF INVENTION

An optical device includes a conductive frame; a sensor member mounted on a lower surface of the conductive frame; an aperture member covering the sensor member and having an aperture corresponding to the sensor member; a lighting member arranged on an extension portion of the conductive frame; a protection member packaging the lighting member and the aperture member onto the conductive frame, wherein the protection member is transparent and made integrally in one piece with the conductive frame, and the protection member has a light-condensing portion protruded therefrom and relative to the aperture and the sensor member sequentially, whereby The lighting member provides light onto an object, which is disposed beneath the protection member, and the light is reflected to the light-condensing portion and further incident into the sensor member via the aperture member.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter and which will form the subject of the claims appended hereto.

### BRIEF DESCRIPTION OF THE DRAWINGS

These and other features, aspects, and advantages of the present invention will become better understood with regard to the following description, appended claims, and accompanying drawings, where:

FIG. 1 is a side view of a first conventional optical system;

FIG. 2 is a side view of a second conventional optical system;

FIG. 3 is a side view of an optical device of a preferred embodiment according to the present invention;

FIG. 4 is a perspective view of the optical device of the preferred embodiment according to the present invention;

FIG. 5A is a decomposition view of an image system according to the present invention;

FIG. 5B is a perspective view of the image system according to the present invention;

FIG. 6A is a decomposition view of an image system of another embodiment according to the present invention;

FIG. 6B is a perspective view of the image system of another embodiment according to the present invention;

FIG. 7 is a side view of a lighting system according to the present invention; and

FIG. 8 is a side view of an application adopted for multiple optical devices according to the present invention.

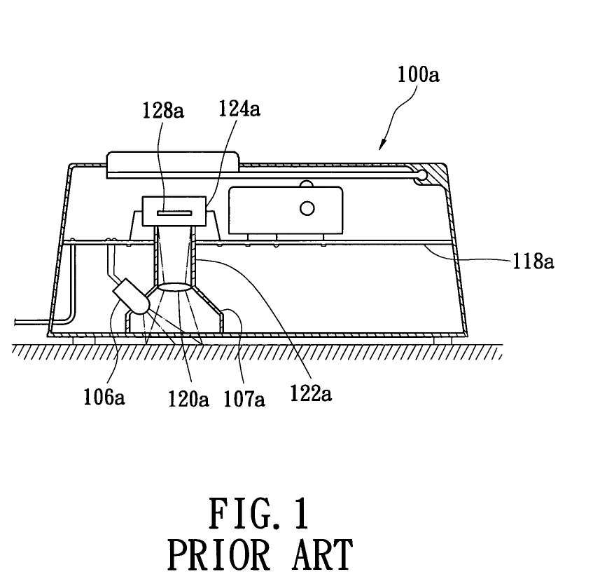

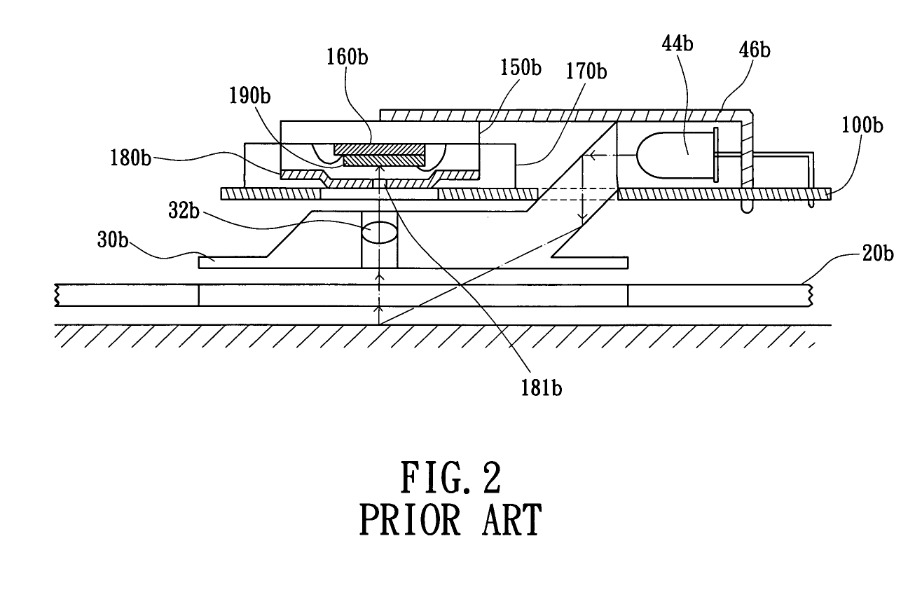

### DETAILED DESCRIPTION OF THE EMBODIMENTS

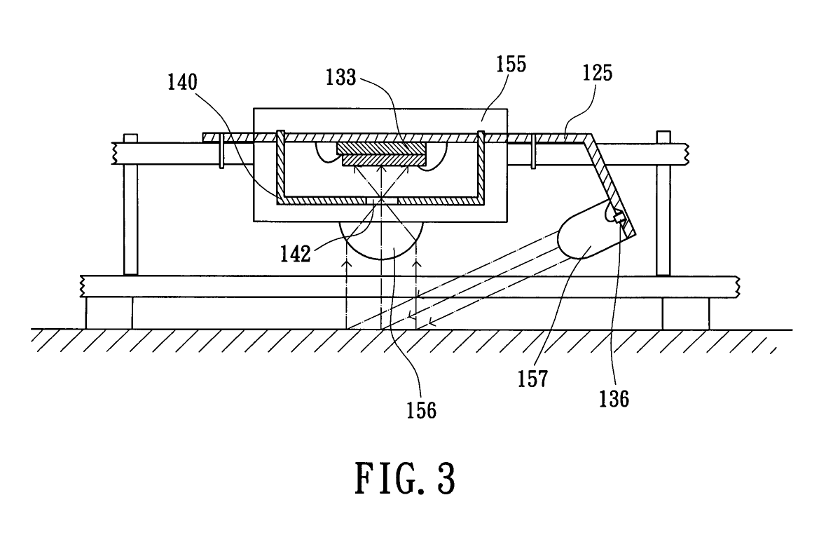

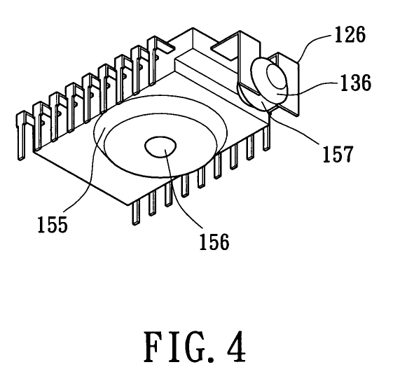

With respect to FIGS. 3 and 4, an optical device includes a conductive frame 125, a sensor member 133 mounted on a lower surface of the conductive frame 125, an aperture member 140 covering the sensor member 133 and having an aperture 142 aligned with and corresponding to the sensor member 133, a lighting member 136 arranged on an extension portion 126 of the conductive frame 140, and a protection member 155 packaging the sensor member 133 and the aperture member 140 onto the conductive frame 125. The protection member 155 is transparent and made integrally in one piece with the conductive frame 125, and the protection member 155 has a light-condensing portion 156 protruded therefrom and relative to the aperture 142 and the sensor member 133 sequentially. The aperture 142 is used to shield stray light in order to increase the image quality. The lighting member 136 provides light onto an object surface, and the sensor member 133 is used to inspect the light reflected from the object surface for image sketching. The quantity of the light-condensing portion is at least one; the light from the lighting member is delivered by passing through the light-condensing portion or the light-condensing portions. Therefore, a subsidiary light-condensing portion 157 is formed to relating to the lighting member 136 for a guarantee of the safeguard.

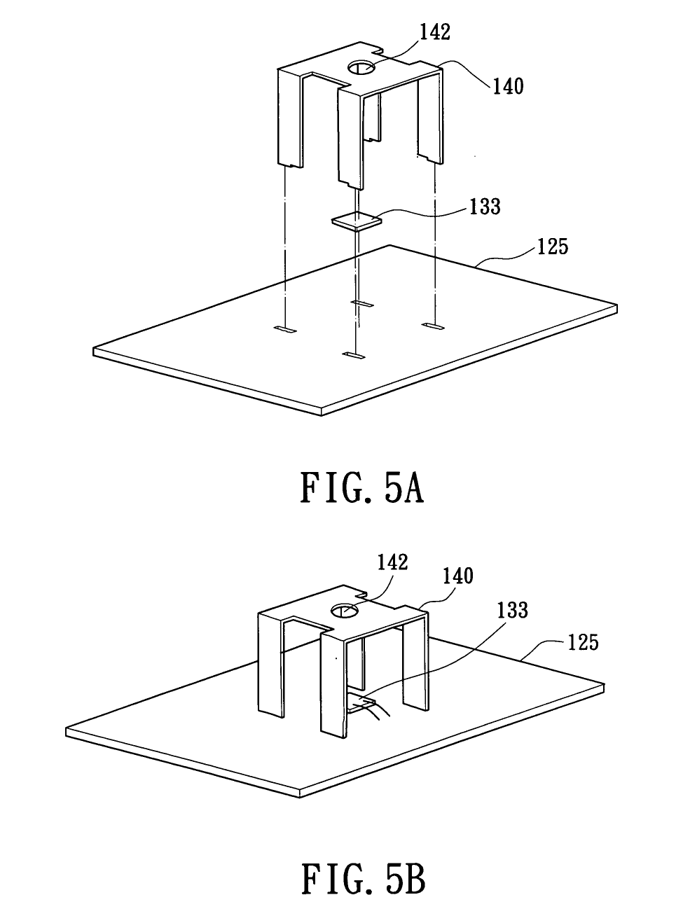

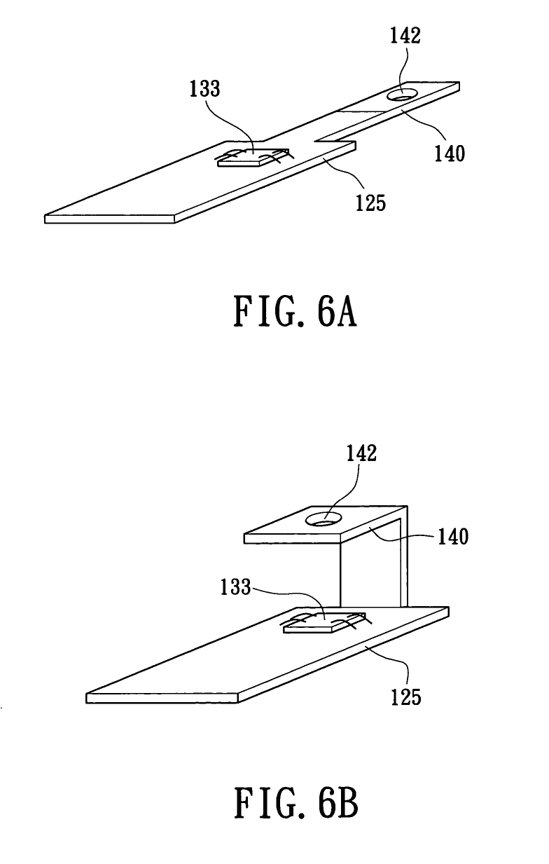

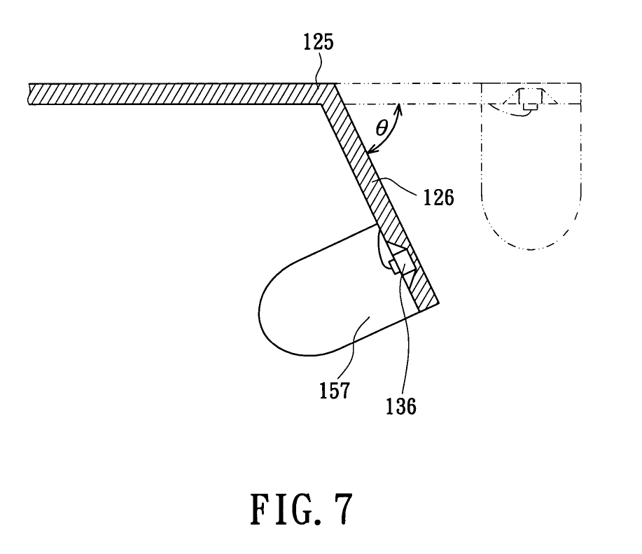

The method for manufacturing the optical device includes steps: (a) securing and leading the sensor member 133 onto a lower surface of the conductive frame 125. The sensor member 133 is a CMOS (Complementary Metal-Oxide Semiconductor), a PD (Photo Diode), a CCD (Charge Coupled Device), or a PM (Photo Multiplier). (b) Fastening a lighting member 136 onto an extension of the conductive frame 125. The light member 136 is an LED (Light Emitting Diode) or LD (Laser Diode) die, a wavelength thereof ranges from 400 nm to 1000 nm. The lighting member 136 is bonded to connect electrically to the sensor member 133. (c) Making an aperture member 140, which has an aperture 142, combine with the conductive frame 125 by an aperture planting technology in order to enclose the sensor member 133, which is aligned with the aperture 142. The aperture member 140 is secured to the conductive frame 125 in insetting or adhesive manner (shown in FIGS. 5A and 5B). Alternatively, the aperture member 140 is molded with the conductive frame 125 integrally in one piece, or the aperture member 140 is assembled to the conductive frame 125 (shown in FIGS. 6A and 6B). And (d), packaging the lighting member 136 and the aperture member 140 onto the conductive frame 125 with a protection member 155 simultaneously, wherein the protection member 155 has a light-condensing portion 156 relating to the aperture 142 of the aperture member 140, so as to enable the light from the lighting member 136 be incident into the sensor member 133 via the aperture 142 after reflected by an object. The protection member 155 is made of Epoxy or thermosetting plastic materials, which are poured into a mold to package all the elements and form the light-condensing portion 156 relative to the aperture member 140 and a subsidiary light-condensing portion 157 relative to the lighting member 136 simultaneously. The present application is to make the protection member 155 with the conductive frame 125 integrally to protect and secure the sensor member 133 and the lighting member 136. The protection member 155 further functions as an imaging lens, so as to omit the arrangement of the lens. Thus, the tolerance can be controlled and diminished, and the costs can be saved thereby. The light-condensing portion 156 is formed beneath the sensor member 133 and is used for imaging. The subsidiary light-condensing portion 157 formed beneath the lighting member 136 is primarily to concentrate the light. With respect to FIG. 7, the optical device can undergo a bending process to form the extension portion 126 molded downwardly from the conductive frame 125 integrally in one piece and with a predetermined angle θ. The lighting member 136 is disposed in the extension portion 126, so that the light is directed with a proper projecting angle to the object surface. The extension portion 126 includes a recess and a reflection surface formed at the recess, which can be bowl-like, and the lighting member 136 is disposed in the recess. The predetermined angle θ can range from about 0 to 90 degrees, and particularly can range from 60 to 70 degrees, so that the projecting angle to the object surface ranges from 20 to 30 degrees. The aperture 142 relative to the sensor member 133 is aligned. The lighting member 136 and the sensor member 133 are secured and packaged onto the conductive frame 125 with the transparent protection member 155.

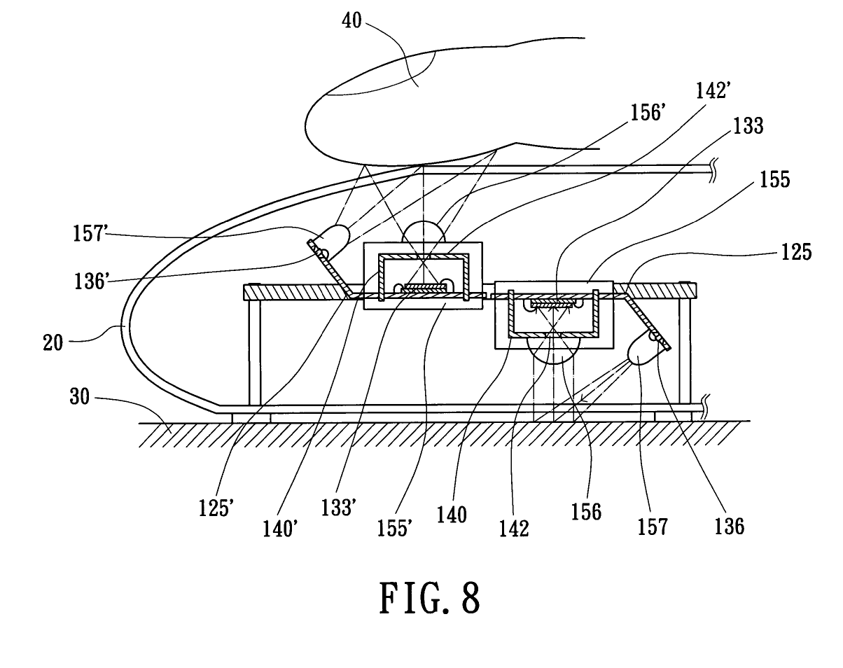

Therefore, the optical device according to the present invention can improve the image quality and omit the tolerance existing therebetween, and further is adapted for an image reorganization system with a high precision to recognize, for example, fingerprints or an iris. FIG. 8 shows an optical mouse 20 including two sets of optical device according to the present invention. One of the two sets is used for checking the position information, and the other is used for checking a fingerprint. The lighting member 136 of the position optical device provides light for an object surface, the sensor member 133 is used to check the image of the object surface, and the protection member 155 is used to secure and protect the lighting member 136 and the sensor member 133. A lighting member 136′ of the fingerprint optical device provides light for fingerprints 40, a sensor member 133′ is used for checking the fingerprints 40. A protection member 155′ is arranged in the position of the optical device. Information from two sets of the optical devices can be managed at the same time, so that this kind of arrangement can be applied with, for example, an Information Appliance, an electronic product, or a security management system.

In another embodiment, a step that forming a microstructure, which is capable of directing the light, on the conductive frame can be practiced. In this case, the process of bending the conductive frame 125 with the predetermined angle θ can be omitted.

Referring to FIGS. 5A and 5B, the aperture member 140 is assembled to the conductive frame 125. First, the sensor member 133 is secured to the conductive frame 125, and then the sensor member 133 and the aperture member 140 are leaded and wire bonded to insert in the conductive frame 125 as a whole device. The aperture member 140 is made of metallic or heat-resistant plastic materials. Referring to FIGS. 6A and 6B, the aperture member 140 is molded with the conductive frame 125 integrally in one piece, and the aperture member 140 is also made of metallic or heat-resistant plastic materials.

FIG. 7 illustrates the conductive frame 125 thrusting with a bowl-like recess; there is a reflective surface formed at the recess. The lighting member 136 is disposed in the recess and is leaded to connect electrically the conductive frame 125. The subsidiary light-condensing portion 157 of the protection member 155 plays the same role as a lens to change the lighting angle so as to concentrate the light. The bending portion 126 carrying the lighting member 136 can be shaped with the predetermined angle θ to focus the light on the object surface effectively. The lighting efficiency according to the present invention is more than twice that of the conventional art.

After the protection member 155 is packaged, the exposed lead of the optical device can be bent in a DIP (Dual Inline Package) manner (see FIG. 4). Conversely, the optical device is in a SMD (Surface Mounting Device)-type after the package process.

Advantages of the present invention are summarized as follows:

1. The lighting member 136 and the sensor member 133 made on the conductive frame 125 integrally in one piece can omit the assembly steps and differences thereof, and are further processed with package technology for imaging. The image quality is improved thereby.

2. The conductive frame 125 is bent to provide the predetermined angle θ to avoid the optical losses caused by the optical pipes.

3. The optical device is produced as a whole to prevent contamination with dust during assembly, in order to increase the product yield and reduce cost.

4. The package technology according to the present invention reduces the size of the optical device, and, furthermore, the low cost and the simple steps make the optical device broadly applicable.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

1. An optical device, comprising:
a conductive frame;
a sensor member mounted on a lower surface of the conductive frame;
an aperture member covering the sensor member and having an aperture corresponding to the sensor member;
a lighting member arranged on an extension portion of the conductive frame; and
a protection member packaging the lighting member and the aperture member onto the conductive frame, wherein the protection member is transparent and made integrally in one piece with the conductive frame, and the protection member has a light-condensing portion protruded therefrom and relative to the aperture and the sensor member sequentially;
whereby the lighting member provides light onto an object, which is disposed beneath the protection member, and the light is reflected to the light-condensing portion and further incident into the sensor member via the aperture member.

2. The optical device as claimed in claim 1, wherein the quantity of the light-condensing portion is at least one, the light from the lighting member is delivered by passing through the light-condensing portion or the light-condensing portions.

3. The optical device as claimed in claim 1, wherein the lighting member is an LED (Light Emitting Diode) or LD (Laser Diode) die.

4. The optical device as claimed in claim 1, wherein the sensor member is a CMOS (Complementary Metal-Oxide Semiconductor), a PD (Photo Diode), a CCD (Charge Coupled Device), or a PM (Photo Multiplier).

5. The optical device as claimed in claim 1, wherein the protection member is made of Epoxy or thermosetting plastic materials.

6. The optical device as claimed in claim 1, wherein the extension portion is molded downwardly from the conductive frame with a predetermined angle and made integrally with the conductive frame in one piece, and the lighting member is disposed in the extension portion.

7. The optical device as claimed in claim 6, wherein the extension portion comprises a recess and a reflection surface formed at the recess, the lighting member is disposed in the recess.

8. The optical device as claimed in claim 7, wherein the recess is bowl-like.

9. The optical device as claimed in claim 6, wherein the predetermined angle ranges from about 60 to 70 degrees, so as to enable a projecting angle to a surface of the object range from about 20 to 30 degrees.

10. The optical device as claimed in claim 1, wherein the conductive frame comprises a microstructure, which is capable of directing the light.

11. The optical device as claimed in claim 1, wherein the aperture member is molded integrally with the conductive frame in one piece.

12. The optical device as claimed in claim 1, wherein the aperture member is assembled to the conductive frame.

13. The optical device as claimed in claim 1, wherein the aperture member is made of metallic or heat-resistant plastic materials.

14. A method for manufacturing an optical device, comprising steps:
securing and leading a sensor member onto a lower surface of a conductive frame;
fastening a lighting member onto an extension of the conductive frame;
making an aperture member, which has an aperture, combine with the conductive member in order to enclose the sensor member, which is aligned with the aperture; and
packaging the lighting member and the aperture member onto the conductive frame with a protection member simultaneously, wherein the protection member has a light-condensing portion relating to the aperture of the aperture member, so as to enable the light from the lighting member be incident into the sensor member via the aperture after reflected by an object.

15. The method as claimed in claim 14, further comprising bending the leads exposed therefrom after the package process, wherein the optical device is in a DIP (Dual Inline Package) manner.

16. The method as claimed in claim 14, wherein the optical device is in a SMD (Surface Mounting Device)-type after the package process.

17. The method as claimed in claim 14, wherein the lighting member is an LED (Light Emitting Diode) or LD (Laser Diode) die.

18. The method as claimed in claim 14, wherein the sensor member is a CMOS (Complementary Metal-Oxide Semiconductor), a PD (Photo Diode), a CCD (Charge Coupled Device), or a PM (Photo Multiplier).

19. The method as claimed in claim 14, wherein the aperture member is secured to the conductive frame in an insetting or adhesive manner.

20. The method as claimed in claim 14, wherein the aperture member is made of metallic or heat-resistant plastic materials.

21. The method as claimed in claim 14, wherein the aperture member is molded integrally with from the conductive frame in one piece.

22. The method as claimed in claim 14, further comprising a step that pouring Epoxy or thermosetting plastic materials into a mold for making the protection member in order to package all the elements thereof and form the light-condensing portion, which functions as an optical lens, simultaneously in an integral manner.

23. The method as claimed in claim 14, further comprising a step that bending the conductive frame with a predetermined angle.

24. The method as claimed in claim 23, wherein the predetermined angle ranges from about 60 to 70 degrees, so as to enable a projecting angle to a surface of the object range from about 20 to 30 degrees.

25. The method as claimed in claim 14, further comprising a recess at the conductive frame and a reflection surface at the recess, wherein the lighting member is disposed in the recess.

26. The method as claimed in claim 14, further comprising a step that forming a microstructure, which is capable of directing the light, on the conductive frame.
